(19) United States
(12) Patent Application Publication
(10) Pub. No.: US 2003/0196699 A1
(43) Pub. Date: Oct. 23, 2003

(54) Valve for pump

(76) Inventor: Chiang-Pei Chen, Ta Li City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/126,135

(22) Filed: Apr. 19, 2002

(51) Int. Cl. F16K 15/20

(52) U.S. Cl. 137/223

(57) ABSTRACT

A valve includes a housing, a first nozzle, a second nozzle and a switch. The housing defines an inlet channel for communication with a pump, a chamber in communication with the inlet channel, a first outlet channel in communication with the chamber and a second outlet channel in communication with the chamber. The first nozzle is in communication with the first outlet channel. The second nozzle is in communication with the second outlet channel. The switch is received in the chamber and movable between a first position where the inlet is communicated with the first outlet channel through the chamber and a second position where the inlet is communicated with the second outlet channel through the chamber. The first nozzle is for engagement with an inlet of a tire. The second nozzle is for engagement with an inlet of a pneumatically adjustable cushion.

### BACKGROUND OF THE INVENTION

1. Field of Invention

The present invention is related to a valve for a pump.

2. Related Prior Art

Many drivers carry portable pumps in their cars for pumping tires. From such a portable pump extends a flexible pipe connected with a nozzle for engagement with an inlet of a tire. Now, many cars are equipped with pneumatically adjustable cushions. Air can be pumped into such a cushion so as to extend its length, thus rendering the cushion “softer.” Of course, air can be released from the cushion so as to reduce its length, thus rendering the cushion “harder.” For a car equipped with pneumatically adjustable cushions, a portable pump is responsible for pumping the tires and the cushions. However, a cushion requires a higher pressure than a tire does. It is found that a nozzle designed for engagement with an inlet of a tire often fails engagement with an inlet of a cushion for being unable to sustain an ultra-high pressure during pumping. To avoid this problem, a portable pump may be equipped with an additional nozzle that is designed for engagement with an inlet of a cushion and can sustain an ultra-high pressure during pumping. However, such an ultra-high pressure nozzle is often forgotten or lost, thus rendering it impossible to pump the cushion. Besides, it is always troublesome to replace an ordinary nozzle with an ultra-high pressure nozzle and vice versa. Moreover, engagement of the ordinary or ultra-high pressure nozzle with the flexible pipe leading from the pump becomes slack after replacement takes place for some times.

The present invention is intended to obviate or at least alleviate the problems encountered in prior art.

### SUMMARY OF THE INVENTION

It is the primary objective of the present invention to provide a valve for tight engagement with an inlet of a tire or pneumatically adjustable cushion.

According to the present invention, a valve includes a housing, a first nozzle, a second nozzle and a switch. The housing defines an inlet channel for communication with a pump, a chamber in communication with the inlet channel, a first outlet channel in communication with the chamber and a second outlet channel in communication with the chamber. The first nozzle is in communication with the first outlet channel. The second nozzle is in communication with the second outlet channel. The switch is received in the chamber and movable between a first position where the inlet is communicated with the first outlet channel through the chamber and a second position where the inlet is communicated with the second outlet channel through the chamber. The first nozzle is for engagement with an inlet of a tire. The second nozzle is for engagement with an inlet of a pneumatically adjustable cushion.

In a first aspect, the switch can slide. The switch includes a piston and a rod extending from the piston, wherein the piston blocks the inlet from the second outlet channel in the first position, wherein the piston blocks the inlet from the first outlet channel in the second position. The switch defines the second outlet channel. The second outlet channel includes a first end in the piston and a second end in the rod. The inlet channel includes a first end for communication with the pump and a second end communicated with the chamber. The first outlet channel includes a first end communicated with the chamber and a second end communicated with first nozzle. The valve includes a ring mounted on the piston so as to divide the chamber into two regions. In the first position, the second end of the inlet channel and the first end of the first outlet channel are in a region of the chamber while the first end of the second outlet channel is in the other region of the chamber. In the second position, the second end of the inlet channel and the first end of the second outlet channel are in a region of the chamber while the first end of the first outlet channel is in the other region of the chamber.

In a second aspect, the switch can rotate in the chamber. The switch defines a channel through which the inlet channel is communicated with the first outlet channel in the first position and with the second outlet channel in the second position.

Other objects, advantages, and novel features of the invention will become more apparent from the following detailed description when taken in conjunction with the attached drawings.

### BRIEF DESCRIPTION OF THE DRAWINGS

The present invention is described through detailed illustration of embodiments referring to the attached drawings wherein:

FIG. 1 is a cross-sectional view of a valve according to a first embodiment of the present invention in communication with a flexible pipe extending from a pump, showing the valve in a position for pumping air through an ordinary nozzle;

FIG. 2 is similar to FIG. 1 except for showing the valve in a position for pumping air through an ultra-high pressure nozzle;

FIG. 3 is similar to FIG. 1 except for showing the valve directly connected with a cylinder of a pump;

FIG. 4 is similar to FIG. 3 except for showing the valve in a position for pumping air through an ultra-high pressure nozzle;

FIG. 5 is a cross-sectional view of a valve according to a second embodiment of the present invention in communication with a flexible pipe extending from a pump, showing the valve in a position for pumping air through an ordinary nozzle;

FIG. 6 is similar to FIG. 5 except for showing the valve in a position for pumping air through an ultra-high pressure nozzle;

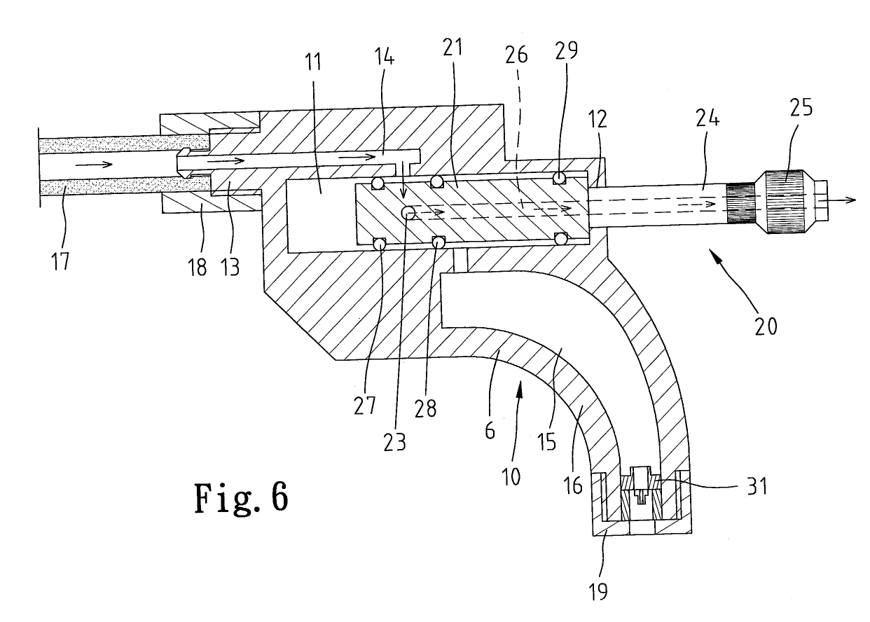

FIG. 7 is similar to FIG. 5 except for showing the valve directly connected with a cylinder of a pump;

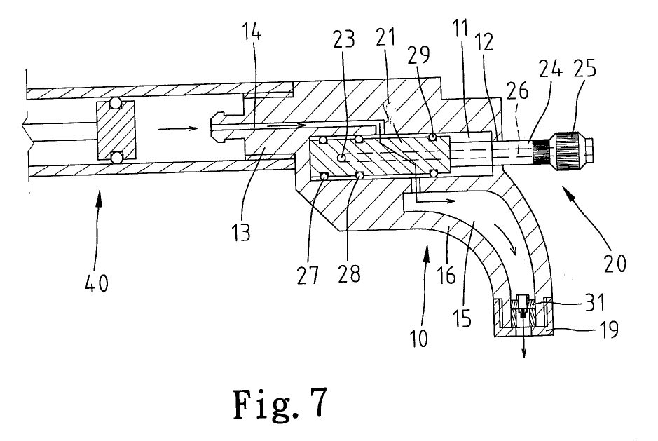

FIG. 8 is similar to FIG. 7 except for showing the valve in a position for pumping air through an ultra-high pressure nozzle;

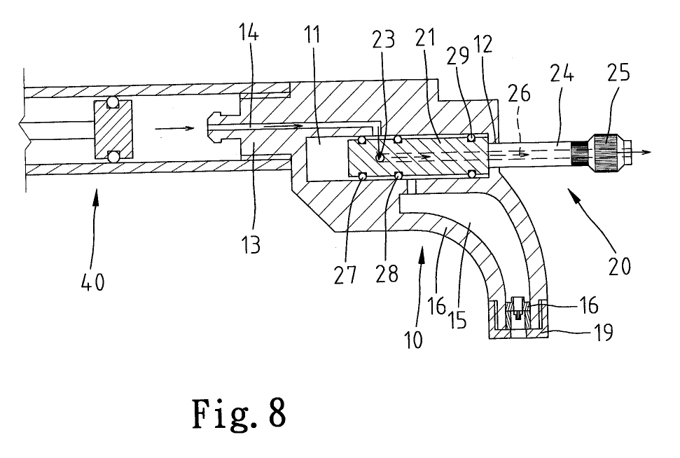

FIG. 9 is a cross-sectional view of a valve according to a third embodiment of the present invention in communication with a flexible pipe extending from a pump, showing the valve in a position for pumping air through an ordinary nozzle;

FIG. 10 is similar to FIG. 9 except for showing the valve in a position for pumping air through an ultra-high pressure nozzle;

FIG. 11 is similar to FIG. 9 except for showing the valve directly connected with a cylinder of a pump; and

FIG. 12 is similar to FIG. 11 except for showing the valve in a position for pumping air through an ultra-high pressure nozzle;

### DETAILED DESCRIPTION OF EMBODIMENTS

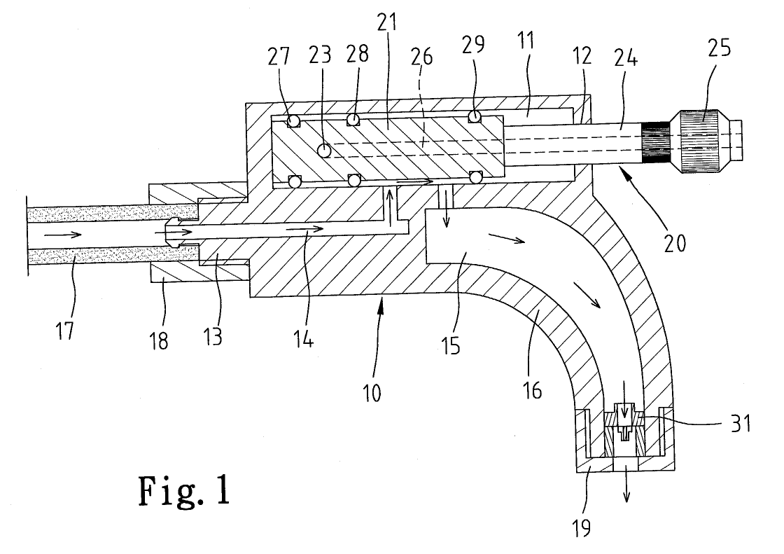

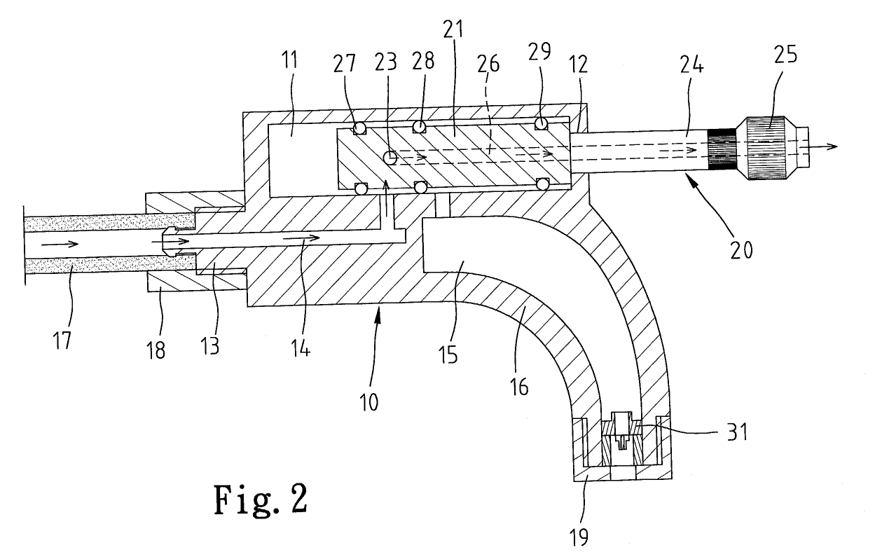

Referring to FIGS. 1 and 2, a valve according to a first embodiment of the present invention includes a housing 10, an ordinary nozzle 31, an ultra-high pressure nozzle 32 and a switch 20.

The housing 10 defines a chamber 11, a hole 12 communicated with the chamber 11, an inlet channel 14 in communication with the chamber 11 and an outlet channel 15 in communication with the chamber 11. The inlet channel 14 extends through a joint 13 projecting from the housing 10 and includes a first end this is open to the external of the housing 10 and a second end that is open to the chamber 11. The joint 13 includes a root and a tip thinner than the root. The tip of the joint 13 can be inserted in an end of a flexible pipe 17 leading from a pump (not shown). Thus, air can be provided from the pump to the valve. A ring secured to the end of the flexible pipe 17 can be engaged with the root of the joint 13. Thus, communication of the pump with the valve is ensured.

The outlet channel 15 extends through a joint 16 projecting from the housing 10 and includes a first end that is open to the chamber 11 and a second end that is open to the external of the housing 10. The ordinary nozzle 31 is received in the second end of the outlet channel 15. A ring 19 is engaged with an end of the joint 16, thus retaining the ordinary nozzle 31 in the second end of the outlet channel 15.

The switch 20 includes a piston 21 and a rod 24 projecting from the piston 21. The piston 21 is movably received in the chamber 11. The rod 24 is inserted through the hole 12. The ultra-high pressure nozzle 32 is secured to an end of the rod 24 that is exposed to the external of the housing 10.

The periphery of the piston 21 defines a hole 23. The switch 20 defines an outlet channel 26 extending in a radial direction from the hole 23. The outlet channel 26 turns and extends axially in the piston 21 and through the rod 24.

Rings 27, 28 and 29 are respectively received in three annular grooves (not numbered) defined in the periphery of the piston 21. The rings 27, 28 and 29 all contact the wall of the chamber 11, thus partitioning the chamber 11 into several regions that are not communication with one another. The hole 23 is located between the rings 27 and 28.

FIG. 1 shows the valve in a first position where air can be pumped through the ordinary nozzle 31. In the first position, the second end of the inlet channel 14 and the first end of the outlet channel 15 are located between the rings 28 and 29. Thus, the inlet channel 14 is communicated with the outlet channel 15 through a region of the chamber 11 confined between the rings 28 and 29. The second end of the inlet channel 14 is not located between the rings 27 and 28. Thus, the inlet channel 14 is not communicated with the outlet channel 26 through a region of the chamber 11 confined between the rings 27 and 28. The ordinary nozzle 31 can be engaged with an inlet of a tire. Thus, air can be provided from the pump to the tire through the ordinary nozzle 31 of the valve.

FIG. 2 shows the valve in a second position where air can be pumped through the ultra-high pressure nozzle 32. In the second position, the second end of the inlet channel 14 is located between the rings 27 and 28. Thus, the inlet channel 14 is communicated with the outlet channel 26 through the region of the chamber 11 confined between the rings 27 and 28. The first end of the outlet channel 15 is located outside the region of the chamber 11 confined between the rings 27 and 28. Thus, the inlet channel 14 is not communicated with the outlet channel 15. The ultra-high pressure nozzle 32 can be engaged with an inlet of a pneumatically adjustable cushion. Thus, air can be provided from the pump to the pneumatically adjustable cushion through the ultra-high pressure nozzle 32 of the valve.

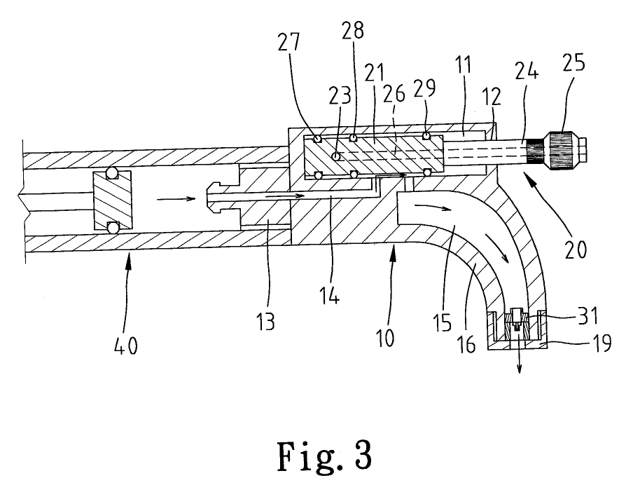

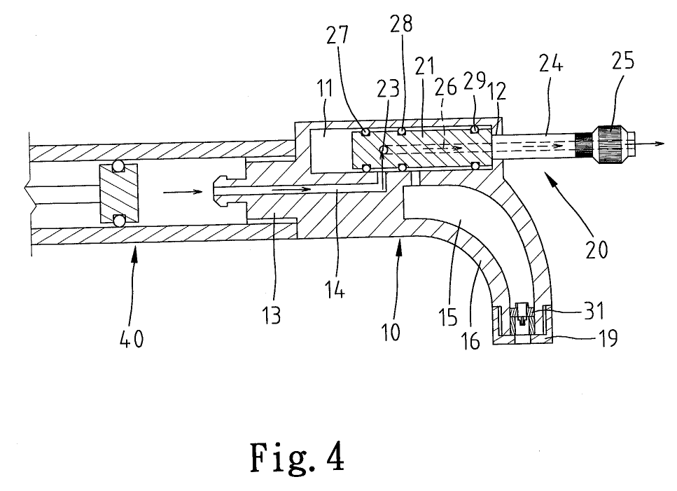

Referring to FIGS. 3 and 4, the joint 13 of the valve is directly engaged with a cylinder 40 of the pump instead of communication through the flexible pipe 17.

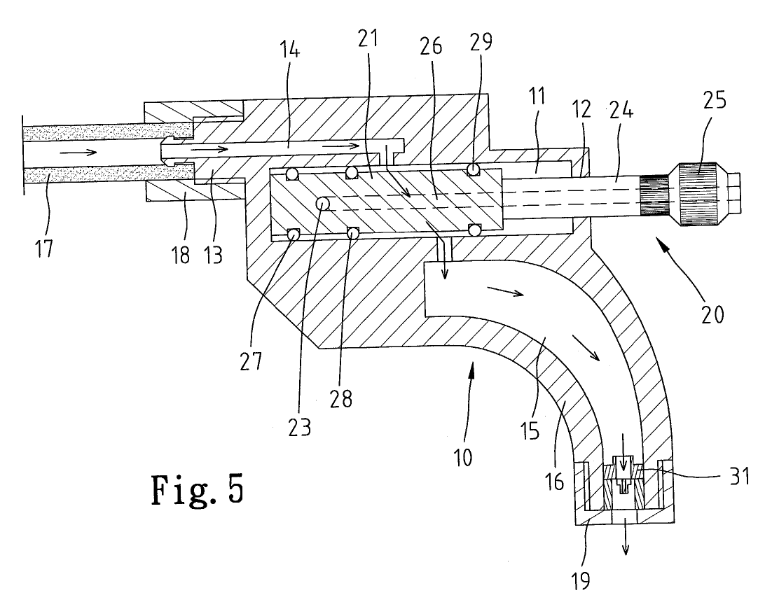

Referring to FIGS. 5˜8, a valve according to a second embodiment of the present invention is shown. The second embodiment is identical to the first embodiment except that the joints 13 and 16 are located on two opposite sides of the chamber 11.

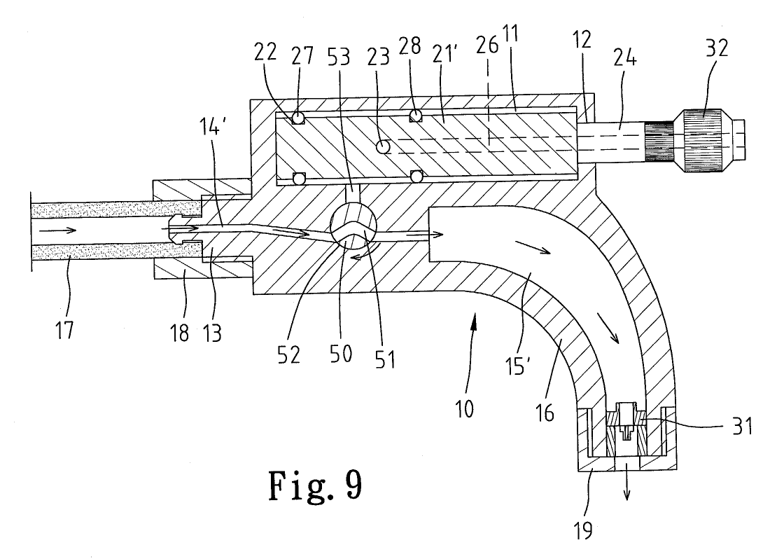

FIGS. 9˜12 show a valve according to a third embodiment of the present invention. The third embodiment uses a housing 10′ and a switch 50 in place of the housing 10 and the switch 20. The housing 10′ defines an inlet channel 14′ and an outlet channel 15′ instead of the inlet channel 14 and the outlet channel 15. The housing 10′ defines a cylindrical chamber 52 and an outlet channel 53. The cylindrical chamber 52 is in communication with the chamber 11 through the outlet channel 53. The inlet channel 14′ is in communication with the cylindrical chamber 52 instead of the chamber 11. The outlet channel 15′ includes a first end that is open to the cylindrical chamber 52 instead of the chamber 11. The switch 50 is shaped as a shaft defining a transverse channel 51. The switch 50 is inserted and can be rotated in the cylindrical chamber 52.

Third embodiment uses a core 21′ instead of the piston 21. The core 21′ is identical to the piston 21 except for defining only two annular grooves for receiving only two rings 27 and 28. In operation, the core 21′ does not slide in the chamber 11 because it is not a component of a switch.

FIG. 9 shows the valve in a position wherein air can be pumped through the ordinary nozzle 31. In the first position, the second end of the inlet channel 14 is in communication with the first end of the outlet channel 15 through the channel 51.

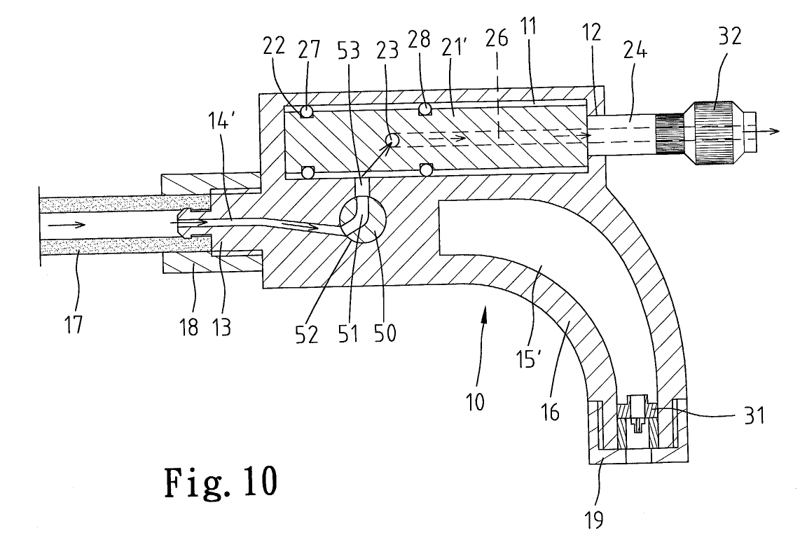

FIG. 10 shows the valve in a second position where air can be pumped through the ultra-high pressure nozzle 32. In the second position, the second end of the inlet channel 14 is in communication with the outlet channel 53 through the channel 51. The channel 53 is communicated with the outlet channel 26 through the region of the chamber 11 confined between the rings 27 and 28.

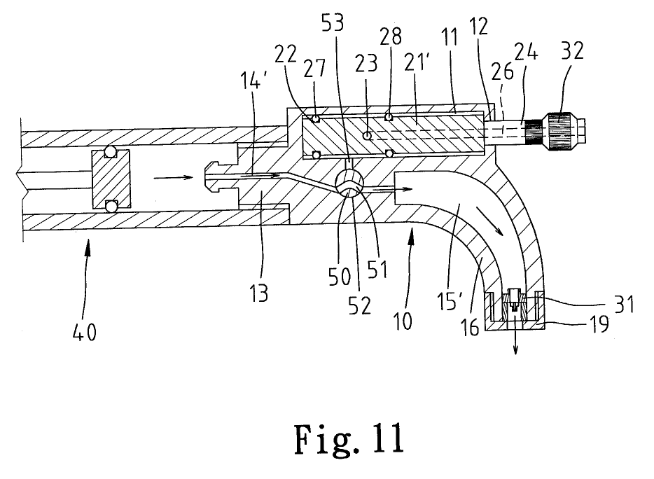

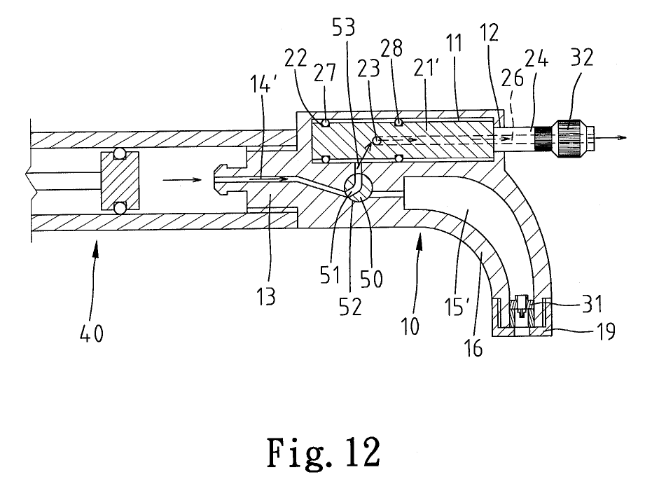

Referring to FIGS. 11 and 12, the joint 13 of the valve is directly engaged with a cylinder 40 of the pump instead of through the flexible pipe 17.

The present invention has been described through detailed illustration of several embodiments. Those skilled in the art can derive many variations from the embodiments without departing from the scope of the present invention. Therefore, the embodiments shall not limit the scope of the present invention that can only be defined in the attached claims.

1. A valve including:
a housing defining an inlet channel for communication with a pump, a chamber in communication with the inlet channel, a first outlet channel in communication with the chamber and a second outlet channel in communication with the chamber;
a first nozzle in communication with the first outlet channel;
a second nozzle in communication with the second outlet channel; and
a switch received in the chamber and movable between a first position where the inlet is communicated with the first outlet channel through the chamber and a second position where the inlet is communicated with the second outlet channel through the chamber.

2. The valve according to claim 1 wherein the first nozzle is for engagement with an inlet of a tire.

3. The valve according to claim 1 wherein the second nozzle is for engagement with an inlet of a pneumatically adjustable cushion.

4. The valve according to claim 1 wherein the switch can slide.

5. The valve according to claim 4 wherein the switch includes a piston and a rod extending from the piston, wherein the piston blocks the inlet from the second outlet channel in the first position, wherein the piston blocks the inlet from the first outlet channel in the second position.

6. The valve according to claim 5 wherein the switch defines the second outlet channel, wherein the second outlet channel includes a first end in the piston and a second end in the rod.

7. The valve according to claim 6 wherein the inlet channel includes a first end for communication with the pump and a second end in communication with the chamber, wherein the first outlet channel includes a first end in communication with the chamber and a second end in communication with first nozzle.

8. The valve according to claim 7 including a ring mounted on the piston so as to divide the chamber into two regions, wherein the second end of the inlet channel and the first end of the first outlet channel are in a region of the chamber while the first end of the second outlet channel is in the other region of the chamber in the first position, wherein the second end of the inlet channel and the first end of the second outlet channel are in a region of the chamber while the first end of the first outlet channel is in the other region of the chamber in the second position.

9. The valve according to claim 1 wherein the switch can rotate.

10. The valve according to claim 9 wherein the switch defines a channel through which the inlet channel is communicated with the first outlet channel in the first position and with the second outlet channel in the second position.
